(19) United States
(12) Patent Application Publication
(10) Pub. No.: US 2015/0148123 A1
(43) Pub. Date: May 28, 2015

(54) Video Capturing Device and Video Capturing Method

(71) Applicant: AVerMedia TECHNOLOGIES, INC., NEW TAIPEI CITY (TW)

(72) Inventors: Shou-Kuo Tai, Taipei Hsien (TW); Chun-Tang Hsu, Taipei Hsien (TW)

(73) Assignee: AVerMedia TECHNOLOGIES, INC., NEW TAIPEI CITY (TW)

(21) Appl. No.: 14/086,993

(22) Filed: Nov. 22, 2013

(51) Int. Cl. A63F 13/00

(52) U.S. Cl. CPC A63F 13/00
USPC 463/31

(57) ABSTRACT

Disclosed herein is a video capturing device and video capturing method thereof. The video capturing method includes the steps of: capturing a video history displayed on a display device under the control of a game console; storing the captured video history as a video history file; passing through a game server to read a game information stored in a data reading device; and naming and categorizing the video history file based on the game information.

### BACKGROUND

1. Field of Invention

The present invention relates to a video capturing technology. More particularly, the present invention relates to a video capturing device and a video capturing method for naming and classifying the video capturing file automatically.

2. Description of Related Art

The video game console is a machine for playing software game. The video game console may be regarded as one kind of computers because the main constituent elements in the video game console are the same as that in the computers. In comparison of the computer, the video game console is more capable of exhibiting quality image and sound, as well as the strengthened operation function. Further, various software and hardware may also be installed in the video game console as that in the computer. Although the computer may have the greater flexibility in hardware, it cannot support the respective software games well enough as the video game console does. The hardware elements of the game console include a CPU, a memory, a storage media, a video output device, a signal input device, and etc. The signal input device of the game console is also known as a controller, a lever, or a rocker.

There are generally three kinds of naming methods in the conventional video capturing technology applied to the game console. First, the name of the video file is assigned by a system, but the name may not be named accurately and be unable to be searched and managed by the user. Second, the name is customized through a user; however, the user is required to further input the name, which may be inconvenient in the operation of on some special models. Third, the name is assigned through EPG information (network information), but there is not definitive schedule list to be referred to for capturing the game video, which thus is one of the important subjects and the objective to be solved.

### SUMMARY

A video capturing device and a video capturing method are provided to resolve the problems met in the art.

According to an embodiment of the present invention, the video capturing device includes a capture module, a storage module, a network module, and a read module, and an operating module. The capture module is electrically connected to a game console and a display device, and it is configured to capture the video history controlled by the game console and displayed on the display device. The storage module is electrically connected to the capture module and configured to store the video history captured by the capture module at least one video history file. The network module is connected to a game server through network. The read module is electrically connected to the network module and configured to read a game information from the game server. The an operating module electrically connected to the storage module, and configured to get the game information from the read module, name the video history file in the storage module based on the game information, and classify the video history file.

In an embodiment, the game information is composed of a plurality of game time records, a corresponding game name, a corresponding game chapter, and a corresponding game class.

In an embodiment, the video capturing device further includes an input module that is electrically connected to the operating module and the capture module, and it is configured to accept the control signal

In an embodiment, the control signal is a login information, and the read module gets the game information based on the input module accepted by the login information through the network module.

In an embodiment, the read module gets the game information corresponding to the login information in the game database through the game server, and the game information of the login information synchronized from the game console to the game database of the game server.

In an embodiment, the control signal is one of a starting capture signal and an ending capture signal. The capture module starts capturing the video history transmitted from the game console to the display device when the capture module receives the starting capture signal, and the capture module ends capturing the video history transmitted from the game console to the display device and stores the video history which is captured by the capture module to the storage module when the capture module receives the ending capture signal.

In an embodiment, the operating module reads one of the plurality of game time records which is closest to the file building time of the video history file, the corresponding game name, the corresponding game chapter, and the corresponding game class based on the game information through the network module. Further, one of the game time records names the video history file according to the corresponding game name and the corresponding game chapter, and classifies the video history file according to the corresponding game class.

In an embodiment, the video capturing device further includes an output module that is electrically connected to the input module and the display device, and configured to display the game time records of the game information on the display device, and the control signal selected from one of the game time records of the game information on the display device.

In an embodiment, the operating module reads the corresponding game name, the corresponding game chapter, and the corresponding game class in the game information when the input module selects one of the game time records, names the video history file according to the corresponding game name and the corresponding game chapter, and classifies the video history file according to the corresponding game class.

According to an embodiment of the present invention, the video capturing method includes: capturing a video history controlled by a game console and displayed on the display device; storing the video history captured by the capture module as at least one video history file; reading a game information from a game server through network; and naming and classifying the video history file based on the game information.

In an embodiment, the game information is composed of a plurality of game time records, a corresponding game name, a corresponding game chapter, and a corresponding game class.

In an embodiment, the video capturing method further includes accepting the control signal.

In an embodiment, the control signal is a login information and gets the game information based on the accepted login information.

In an embodiment, the read module gets the game information corresponding to the login information in the game database through the game server, and the game information corresponding to the login information is synchronized from the game console to the game database of the game server.

In an embodiment, the control signal is one of a starting capture signal and a ending capture signal, starting capturing the video history transmitted from the game console to the display device when receiving the starting capture signal, and ending capturing the video history transmitted from the game console to the display device and stores the captured video history when receiving the ending capture signal.

In an embodiment, the video capturing method further includes reading one of the game time records which is closest to the file building time of the video history file, the corresponding game name, the corresponding game chapter, and the corresponding game class based on the game information, naming the video history file based on the corresponding game name and the corresponding game chapter, and classifying the video history file based on the corresponding game class.

In an embodiment, the video capturing method further includes displaying the plurality of game time records of the game information on the display device, and selecting one of the plurality of game time records displayed on the display device to be the control signal.

In an embodiment, the video capturing method further includes reading the corresponding game name, the corresponding game chapter, and the corresponding game class in the game information when selecting one of the plurality of game time records, names the video history file based on the corresponding game name and the corresponding game chapter, and classifies the video history file based on the corresponding game class.

In summary, the present invention has significant advantages and higher performance than current technology. With the present invention, we have significant improvement in video capturing techniques, and it is worthwhile to be widely used and implemented in industry. Advantages of the present invention are to apply the video capturing technology for naming the files in the video capturing device and solve the problem that the video file cannot be named and classified meaningfully due to the game contents not get.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a video capturing device according to an embodiment of the present invention; and

FIG. 2 is a flow chart of a video capturing method according to an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts. In addition, the well-known components and steps are not described in the embodiments to avoid unnecessary limitations to the present invention.

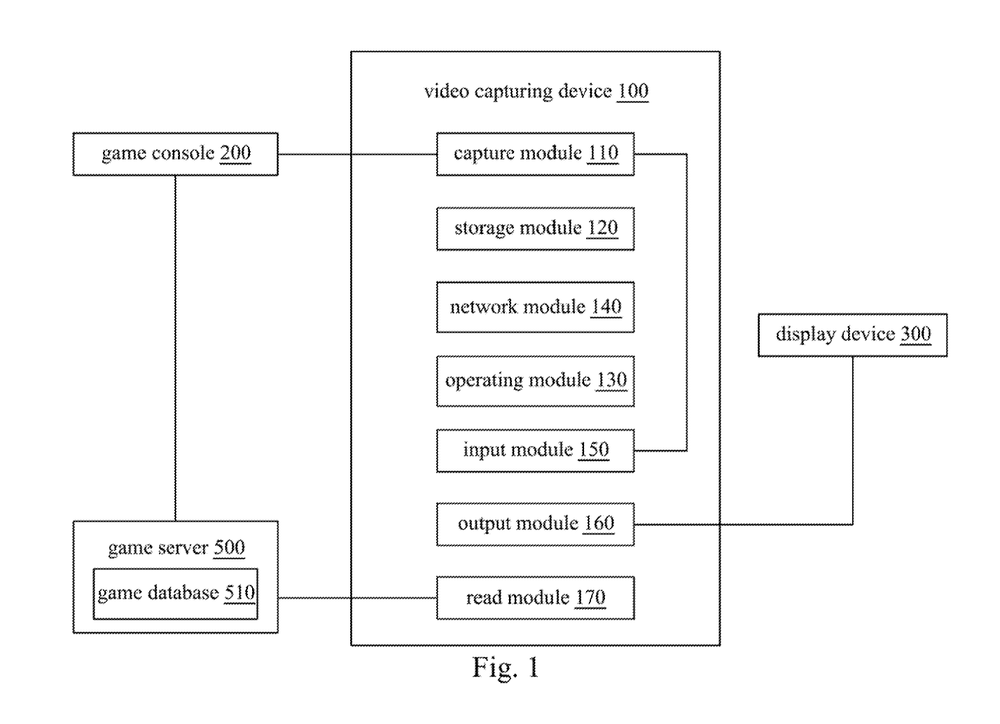

FIG. 1 is a schematic diagram of a video capturing device 100 according to an embodiment of the present invention. As shown in FIG. 1, a game console 200 may be connected to a display device 300 through the video capturing device 100. For example, the game console 200 may be Xbox 360, PS3, Wii, etc., and the display device 300 may be a LCD displayer, a television, a touch pad, etc. When the user controls the game console 200, the game console 200 responds to the corresponding control screen through the display device 300. When the video capturing device 100 is set between the game console 200 and the display device 300, the video capturing device 100 may capture the video history controlled by the game console 200 and displayed on the display device 300. The video history includes image and sound.

In practice, the video capturing device 100 is applied to name the files in the image capture box. The video capturing device 100 solves a difficult that the game contents cannot be gotten so that the name and the class of the video files have not meaning. The present technology is that the capture box gets the information of a gamer built by the game console agent through the network accessing. The video capturing device 100 determines the current game information of the gamer based on a particular time, and the current game information of the gamer includes the game name, the game chapter, the gamer achievement, etc. The capture box may help the gamer build an accurate name and class of the video file, solve the inconvenience for naming the file in the past time, and help the gamer quickly search and manage the recorded file.

In structure, as shown in FIG. 1, the video capturing device 100 includes a capture module 110, a storage module 120, a network module 130, a read module 170, and an operating module 140. The capture module 110 is electrically connected to the game console 200 and the display device 110, the storage module 120 is electrically connected to the capture module 110, the read module 170 is electrically connected to the network module 130, and the operating module 140 is electrically connected to the storage module 120 and the network module 130. The capture module 110 is configured to capture the video history controlled by the game console 200 and displayed on the display device 300. For example, the capture module 110 may be a video device that is connected to the game console 200 and the display device 300 through the signal transmission interface. Examples for the signal transmission interface are to connect to the game console 200 through USB and to connect to the display device 300 through the combination of HDMI (high-definition multimedia interface), component video connector, and RCA connector. The capture module 110 may include USB to be electrically connected to the game console 200. The game console 200 transmits the output signal (e.g., the direction control signal for the game) of the game console 200 to the display device 300 through the video capturing device 100 by way of USB. The capture module 110 is electrically connected to the display device 300 by way of HDMI. When the video capturing device 100 is connected to the game console 200 and the display device 300, the signal of the game console 200 will be transmitted to the display device 300 through the capture module 110. The capture module 110 will capture the video history controlled by the game console 200 and displayed on the display device 300.

After the capture module 110 captures the video history, the video history will be stored as a video history file (e.g., MPEG format, AVI format, 3GP format) through the storage module 120 to provide the user reading or sharing. The storage module 120 is configured to store the video history captured by the capture module 110 as the video history file. The storage module 120 may be a store-enabled device or apparatus, for example, DRAM, hard disk, memory disk, etc.

When the video history file is stored in the storage module 120, the video capturing device 100 may name and classify the video history file based on the game program that is executed on the game console 200 by the user. When the user would like to read or share the video history file in the future, the user will identify the video history file based on the name and class of the file. The network module 130 (e.g., wireless distant communication module, 3G communication module, 4G communication module, or wire network communication module) that is included in the video capturing device 100 is connected to the game server 500. The read module 170 is configured to read the game information from the game server 500 through the network module 130. The game console 200 that is used by the user is also connected to the corresponding game server 500. All game information in the game console 200 will be synchronized to the game server 500 during the process that the user uses the game console 200 to log in the game server 500 to log out the game server 500. The game database 510 that is related to the game server 500 stores the game information (e.g., the username, the game name used by the user, the game achievement) of the users who use the same style or series game console. The read module 170 may be connected to the game server 500 related to the game console 200 and read the game information of the user in the game database 510 through the game server 500.

The operating module 140 is configured to get the game information from the read module 170, and it names and classifies the video history file in the storage module 120 based on the game information. For example, the operating module 140 may be a CPU, a microcontroller, a processing chip, or the other operational elements. The video capturing device 100 is connected to the game server 500 through network. After the read module 170 reads the game information of the user, the operating module 140 names and classifies the video history file based on the game information of the user. In an embodiment, the game information is composed of the game time records the corresponding game name, the corresponding game chapter, and the corresponding game class. For example, the read module 170 reads and accesses the current game name (e.g., Gears of War 3) and the class (e.g., Shooter), the video capturing device 100 takes the information to name and classify the video history file. For example, the name of the video history file is “Gear of War 3-130611”, and the class of the video history file is “Shooter”.

As shown in FIG. 1, the video capturing device 100 further includes an input module 150. The input module 150 is electrically connected to the operating module 140 and the capture module 110, and it is configured to accept a control signal. In practice, the game console 200 and the read module 170 of the video capturing device 100 must be connected to the game server 500 and logged in the game server 500 at the same time. The read module 170 can be logged in the game server 500 by two logging names. Therefore, in an embodiment, the control signal is login information (e.g., a game logging name), and the read module 170 gets the game information based on the login information that is accepted by the input module 150 through the network module 130. The read module 170 gets the game information of the corresponding login information in the game database 510 through the game server 500. The game information of the login information is synchronized from the game console 200 to the game database 510 of the game server 500.

In an embodiment, the control signal is one of a starting capture signal and an ending capture signal. When the capture module 110 receives the starting capture signal, the capture module 110 starts capturing the video history that is transmitted from the game console 200 to the display device 300. When the capture module 110 receives the ending capture signal, the capture module 110 ends capturing the video history that is transmitted from the game console 200 to the display device 300 and stores the captured video history in the storage module 120.

In an embodiment, the operating module 140 reads one of the game time records which is closest to the file building time of the video history file, the corresponding game name, the corresponding game chapter, and the corresponding game class based on the game information through the network module 130, names the video history file according to the corresponding game name and the corresponding game chapter, and classifies the video history file according to the corresponding game class.

As shown in FIG. 1, the video capturing device 100 further includes an output module 160. The output module 160 is electrically connected to the input module 150 and the display device 300, and it is configured to display the game time records of the game information on the display device 300. The control signal is selected from one of the game time records of the game information on the display device 300. In an embodiment, when the input module 150 selects one of the game time records, the operating module 140 reads the corresponding game name, the corresponding game chapter, and the corresponding game class of the game information based on the one of the game time records, names the video history file as the game name and the game chapter, and classifies the video history file as the game class. For example, the output module 160 may be a video output interface or a similar device.

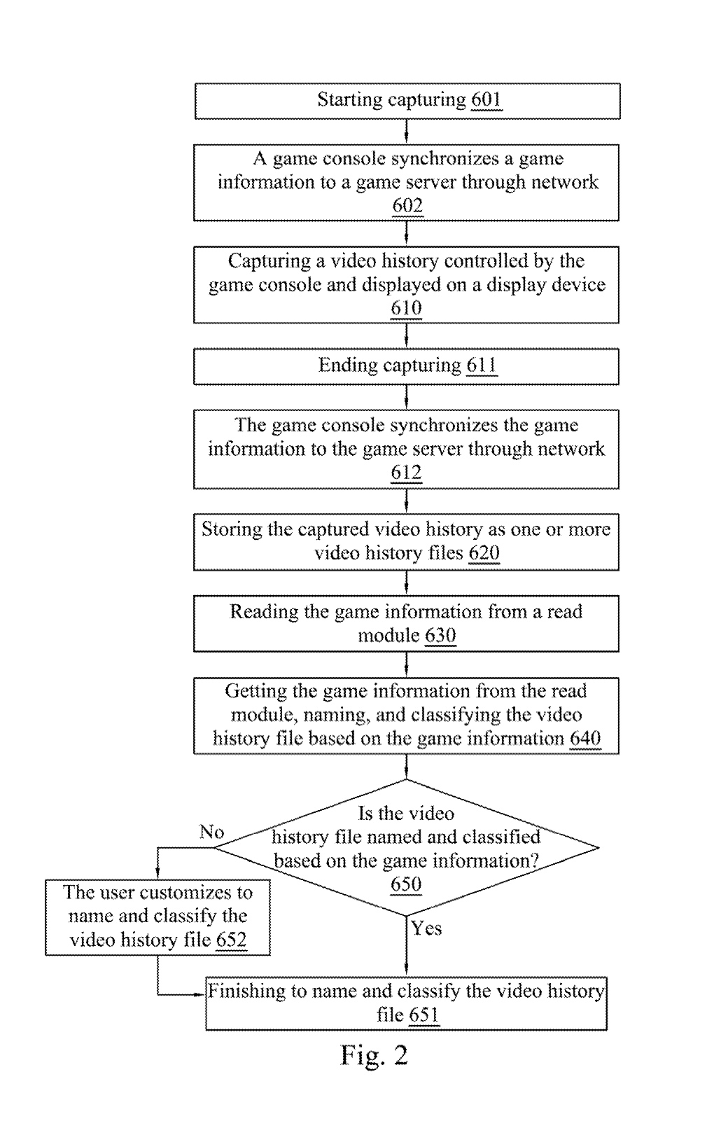

FIG. 2 is a flow chart of a video capturing method according to an embodiment of the present invention. As shown in FIG. 2, the video capturing method includes steps 601-652 (it should be understood that the order of the steps mentioned in the present embodiment may be changed based on actual requirement unless otherwise specified, or the steps may even be performed simultaneously or part of the steps may even be performed simultaneously). Since the hardware devices for implementing steps 601-652 have been specifically disclosed in the above embodiments, further elaboration is not provided.

In step 610, a video history that is controlled by a game console and displayed on a display device is captured. In step 620, the video history that is captured by the capture module is stored as one or more video history files. In step 630, game information is read from a read module. In step 640, the game information is gotten from a read module, and the video history file is named and classified based on the game information. In step 650, the user is asked if he agrees to name and classify the video history file based on the game information. If the user agrees it, in step 651, the video history file is finished naming and classifying. In an embodiment, the game information is composed of more game time records, the corresponding game name, the corresponding game chapter, and the corresponding game class.

The before mentioned video capturing method further includes accepting a control signal. In an embodiment, the control signal is login information, and it logs in a read module based on the accepted login information. The read module gets the game information that is corresponding to the login information in the game database through the game server. The game information of the login information is synchronized from the game console to the game database of the game server.

In an embodiment, the control signal is one of a starting capture signal and an ending capture signal. In step 601, when the starting capture signal is received, the game console synchronizes the game information to the game server through network in step 602. In step 610, the game console starts capturing the video history that is transmitted from the game console to the display device. In step 611, when the ending capture signal is received, the game console still synchronizes the game information to the game server through network in step 612. In step 620, the captured video history is stored as the video history file. Since the following steps have been specifically disclosed in the above embodiments, further elaboration is not provided.

In an embodiment, the video capturing method further includes to read one of the plurality of game time records which is closest to the file building time of the video history file, the corresponding game name, the corresponding game chapter, and the corresponding game class based on the game information, naming the video history file according to the corresponding game name and the corresponding game chapter, and classifying the video history file according to the corresponding game class.

On the other hand, in step 650, the user is asked if he agrees to name and classify the video history file based on the game information. If the user does not agree it, in step 652, the user may customize the name and class of the video history file. In an embodiment, the user may modify the name and class of the video history file that is set by the video capturing method. In another embodiment, more game time records of the game information are displayed on the display device and provided the user to determine if he agrees to name and classify the video history file based on the game information. The control signal is selected from one of the game time records of the game information on the display device. The corresponding game name, the corresponding game chapter, and the corresponding game class of the game information are read based on the selected game time record when the user selects one of more game time records. The name of the video history file is named according to the game name and the game chapter, and the class of the video history file is classified according to the game class.

In practice, the video capturing device or the video capturing method may be applied to the capture box. When the user records the game history, the capture box may name the video file through the network information directly and help the user search the files quickly. The capture box can allow two login names to log in at the same time and determine the game console, the game disk, even the game contents. The capture box may generate the video files or the thumbnails of the folder through the network information to make the user identify the files easily. The capture box may manage the files through the network information, record the screens of the game history automatically, and classify the files and the screens. Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A video capturing device, comprising:
a capture module electrically connected to a game console and a display device, and configured to capture a video history controlled by the game console and displayed on the display device;
a storage module electrically connected to the capture module, and configured to store the video history captured by the capture module as at least one video history file;
a network module connected to a game server through network;
a read module electrically connected to the network module, and configured to read a game information from the game server; and
an operating module electrically connected to the storage module, and configured to get the game information from the read module, name the video history file in the storage module based on the game information, and classify the video history file.

2. The video capturing device of claim 1, wherein the game information comprises a plurality of game time records, a corresponding game name, a corresponding game chapter, and a corresponding game class.

3. The video capturing device of claim 2, further comprising:
an input module electrically connected to the operating module and the capture module, and configured to accept at least one control signal.

4. The video capturing device of claim 3, wherein the control signal is a login information, and the read module gets the game information based on the login information accepted by the input module through the network module.

5. The video capturing device of claim 4, wherein the read module gets the game information corresponding to the login information in the game database through the game server, and the game information of the login information synchronized from the game console to the game database of the game server.

6. The video capturing device of claim 4, wherein the control signal is one of a starting capture signal and an ending capture signal; the capture module starts capturing the video history transmitted from the game console to the display device when the capture module receives the starting capture signal; and the capture module ends capturing the video history transmitted from the game console to the display device and stores the video history which is captured by the capture module to the storage module when the capture module receives the ending capture signal.

7. The video capturing device of claim 6, wherein the operating module reads one of the game time records which is closest to the file building time of the video history file, the corresponding game name, the corresponding game chapter, and the corresponding game class based on the game information through the network module, names the video history file according to the corresponding game name and the corresponding game chapter, and classifies the video history file according to the corresponding game class.

8. The video capturing device of claim 7, comprising:
an output module electrically connected to the input module and the display device, and configured to display the game time records of the game information on the display device, and the control signal selected from one of game time records of the game information on the display device.

9. The video capturing device of claim 8, wherein the operating module reads the corresponding game name, the corresponding game chapter, and the corresponding game class in the game information when the input module selects one of the game time records, names the video history file according to the corresponding game name and the corresponding game chapter, and classifies the video history file according to the corresponding game class.

10. A video capturing method, comprising:
capturing a video history controlled by a game console and displayed on the display device;
storing the video history captured by the capture module as at least one video history file;
reading a game information from a game server through network; and
naming and classifying the video history file based on the game information.

11. The video capturing method of claim 10, wherein the game information comprises a plurality of game time records, a corresponding game name, a corresponding game chapter, and a corresponding game class.

12. The video capturing method of claim 11, further comprising:
accepting at least one control signal.

13. The video capturing method of claim 12, wherein the control signal is a login information and gets the game information based on the accepted login information.

14. The video capturing method of claim 13, wherein the read module gets the game information corresponding to the login information in the game database through the game server, and the game information corresponding to the login information synchronized from the game console to the game database of the game server.

15. The video capturing method of claim 13, wherein the control signal is one of a starting capture signal and an ending capture signal, starting capturing the video history transmitted from the game console to the display device when receiving the starting capture signal, and ending capturing the video history transmitted from the game console to the display device and storing the captured video history when receiving the ending capture signal.

16. The video capturing method of claim 15, further comprising:
reading one of the game time records which is closest to the file building time of the video history file, the corresponding game name, the corresponding game chapter, and the corresponding game class based on the game information, naming the video history file according to corresponding game name and the corresponding game chapter, and classifying the video history file according to the corresponding game class.

17. The video capturing method of claim 16, further comprising:
displaying the game time records of the game information on the display device, and selecting one of the game time records displayed on the display device to be the control signal.

18. The video capturing method of claim 17, further comprising:
reading the corresponding game name, the corresponding game chapter, and the corresponding game class in the game information when selecting one of the game time records, names the video history file according to the corresponding game name and the corresponding game chapter, and classifies the video history file according to the corresponding game class.
